(19) United States
(12) Patent Application Publication
(10) Pub. No.: US 2006/0091842 A1
(43) Pub. Date: May 4, 2006

(54) Factory line system for robot-arm work stations

(75) Inventor: Noritaka Nishiyama, Anjo-shi (JP)

Correspondence Address: HARNESS, DICKEY & PIERCE, P.L.C., P.O. BOX 828, BLOOMFIELD HILLS, MI, 48303, US

(73) Assignee: DENSO Wave Incorporated, Tokyo (JP)

(21) Appl. No.: 11/258,342

(22) Filed: Oct. 25, 2005

(30) Foreign Application Priority Data
Oct. 29, 2004 (JP) 2004-316424

(51) Int. Cl. G05B 19/19

(52) U.S. Cl. 318/568.11

(57) ABSTRACT

A factory line system includes a series of robot arms arranged alongside a conveyor on which workpieces are transported. Each workpiece is fitted with a data carrier and each robot arm is fitted with a reader/writer that can wirelessly communicate with the data carrier of each workpiece when the latter is in transit between the conveyor and a work station. Specifically, when a first robot arm detects a workpiece, it removes the workpiece from the conveyor to a first work station that performs work on the workpiece and sends result data through the reader/writer of the robot arm to the data carrier and replaces the workpiece from the first work station to the conveyor. When the workpiece is transported, approaching a second robot arm, the latter reads the result data through its reader/writer from the data carrier. According to the result data, the second work station performs work on the workpiece.

### CROSS-REFERENCE TO RELATED APPLICATION

This application is based on Japanese Patent Application No. 2004-316424, filed Oct. 29, 2004, which is incorporated herein by reference.

### BACKGROUND OF THE INVENTION

1. Field of the Invention

The present invention relates to a robot-controlled factory line system that performs a specified work on each material or product item transported on a conveyer system.

2. Description of the Related Art

In a factory line system where a series of work stations are provided alongside a belt conveyer, each work station includes a robot arm that picks up a product item from the conveyor, performs a specified work on it and then returns it the conveyer. In a known factory line system, pallets are provided on the conveyer to carry the materials to be worked on and a data carrier on which data are recorded to instruct the robot arm of each work station. As disclosed in Japanese Patent Publication 06-210556, each pallet on the conveyor system is provided with a data carrier which is constructed of a coil to be inductively coupled with a reader/writer of each work station. The reader/write is also constructed of a coil and fixed in a predetermined position of the work station. The first work station is additionally provided with a video camera that senses the position of the workpiece on each pallet and writes its position data through its reader/writer into the data carrier of the same pallet of the sensed workpiece. Each of subsequent workstations on the downstream side of the first station determines the position of each approaching workpiece by establishing inductive coupling between its reader/writer and the data carrier of the pallet carrying the workpiece. Since the reader/writer of each work station is stationary with respect to the approaching data carrier, the time to keep read data from it is limited. If it is desired to increase the time interval for reading a large volume of data, the conveyor system needs to be stopped whenever each pallet comes to each work station and the cycle time of the system will increase with a resultant low productivity. To reduce the cycle time, the robot arm must be moved at high speeds. However, this requires the robot arm to be driven at high power, constructed of rigid structure and provided with a high-power hand for holding the workpiece. In addition, the robot arm would experience increased acceleration at the start of each stroke and increased deceleration at the end of the stroke, which is likely to cause a damage on a workpiece of relatively soft material by increased arm's holding power. Furthermore, a braking device must be provided to stop or decelerate.

### SUMMARY OF THE INVENTION

It is therefore an object of the present invention to provide a factory line system for robot-arm work stations that permit communication to be established with data carriers for a sufficient time interval for data read/write operations.

The object of the invention is obtained by attaching the data carrier to each workpiece that is carried on the conveyer system and mounting a communication device on the robot arm for wirelessly establishing communication between the data carrier and the communication device when the workpiece is being moved between the conveyor system and a work station.

In general terms, the present invention provides a factory line system comprising a conveyor system that carries a workpiece, a data carrier on the workpiece, a robot arm provided on one side of the conveyor system for handling the workpiece, a communication device attached to the robot arm to wirelessly communicate with the data carrier. Control circuitry is associated with the robot arm and the communication device. The control circuitry control circuitry, associated with the robot arm and the communication device, that operates the robot arm to hold the workpiece and causes the communication device to communicate with the data carrier while the robot arm is proximate to the workpiece.

According to a specific aspect, the present invention provides a factory line system comprising a conveyor system that carries a workpiece, a data carrier, on the workpiece, that stores type-of-work information, a robot arm provided on one side of the conveyor system for handling the workpiece, a reader, attached to the robot arm, that wirelessly communicates with the data carrier when the robot arm is proximate to the workpiece, and control circuitry, associated with the robot arm and the reader, that operates the robot arm to remove the workpiece from the conveyor system, causes the reader to read the type-of-work information from the data carrier while the robot arm is proximate to the workpiece, and operates the robot arm to perform work on the workpiece according to the read type-of-work information.

The factory line system further comprises a further robot arm provided on one side of the conveyor system for handling the workpiece, a reader, attached to the robot arm, that wirelessly communicates with the data carrier, and control circuitry, associated with the further robot arm and the reader, that operates the further robot arm to remove the workpiece from the conveyor system, causes the reader to read the response signal from the data carrier while the robot arm is proximate to the workpiece, and operates the further robot arm to perform work on the workpiece according to the read response signal.

According to a further aspect, the present invention provides a method of operating a factory line system including a conveyor system and a robot arm provided on one side of the conveyor system, comprising the steps of (a) providing a workpiece on the conveyor system, (b) attaching a data carrier to the workpiece, (c) attaching a communication device to the robot arm, the communication device being capable of wirelessly communicating with the data carrier when the robot arm is proximate to the workpiece, and (d) operating the robot arm to hold the workpiece and causing the communication device to communicate with the data carrier while the robot arm is proximate to the workpiece.

According to a further aspect, the present invention provides a factory line system including a robot arm provided in the neighborhood of a conveyor system on which workpieces of different types of work to be performed are transported, the robot arm having a holder fitted to a forward end of the robot arm for holding one of the workpieces and removing the one workpiece from the conveyor system. The factory line system comprises a data carrier, attached to each of the workpieces, that stores information indicating the type of work of the workpiece, tracking control means that controls the robot arm so that the forward end of the robot arm keeps track of the, movement of the one workpiece on the conveyor system, reading means, attached to the forward end of the robot arm, that wirelessly communicates with the data carrier to read the type-of-work information of the one workpiece stored in the data carrier, and work control means that determines work to be performed according to the information read by the reading means and controls the robot arm according the determined work. The reading means performs reading of the stored information from the one workpiece during a time interval that runs from the instant the forward end of the robot arm approaches the one workpiece while the same is being transported on the conveyor system and then kept track of by the forward end to the instant the one workpiece is removed from the conveyor system.

According to a still further aspect, the present invention provides a factory line system including a robot arm provided in the neighborhood of a conveyor system on which a workpiece is transported, the robot arm having a holder fitted to a forward end of the robot arm for holding the workpiece and removing the one workpiece from the conveyor system to a work station and replacing the workpiece to the conveyor system after work is performed by the work station on the workpiece. The factory line system comprises a data carrier, attached to the workpiece, into which information is written and from which the stored information is read out, tracking control means that controls the robot arm so that the forward end of the robot arm keeps track of the movement of the conveyor system, ommunication means that receives work result information from the work station, the information indicating a result of the work performed by the work station on the workpiece, and writing means, attached to the forward end of the robot arm, that writes the work result information of the workpiece into the data carrier. The writing means performs writing of the work result information into the data carrier during a time interval that runs from the instant the forward end of the robot arm approaches the workpiece on the work station and then keeps track of the movement of the conveyor system to the instant the workpiece is replaced to the conveyor system.

According to a still further aspect, the present invention provides a factory line system comprising a conveyor system on which a workpiece is transported, a first robot arm having a holder fitted to a forward end of the first robot arm for holding the workpiece and removing the one workpiece from the conveyor system to a work station and replacing the workpiece to the conveyor system after work is performed by the work station on the workpiece, a second robot arm having a holder fitted to a forward end of the second robot arm for holding the workpiece and removing the one workpiece from the conveyor system to perform work, a data carrier, attached to the workpiece, into which information is written and from which the stored information is read out, first tracking control means that controls the first robot arm so that the forward end of the first robot arm keeps track of the movement of the conveyor system, communication means that receives work result information from the work station, the information indicating a result of the work performed by the work station on the workpiece, and writing means, attached to the forward end of the first robot arm, that writes the work result information of the workpiece into the data carrier, second tracking control means that controls the second robot arm so that the forward end of the second robot arm keeps track of the movement of the workpiece on the conveyor system, reading means, attached to the forward end of the robot arm, that wirelessly communicates with the data carrier to read the type-of-work information of the one workpiece stored in the data carrier, and work control means that determines work to be performed according to the information read by the reading means and controls the second robot arm according the determined work. The writing means performs writing of the work result information into the data carrier during a time interval that runs from the instant the forward end of the first robot arm approaches the workpiece on the work station and then keeps track of the movement of the conveyor system to the instant the workpiece is replaced to the conveyor system. The holder of the second robot arm holds the workpiece while the forward end of the second robot arm is tracking the movement of the workpiece on the conveyor system. The reading means performs reading of the stored information from the one workpiece during a time interval that runs from the instant the forward end of the second robot arm approaches the one workpiece while the same is being transported on the conveyor system and then kept track of by the forward end of the second robot arm to the instant the one workpiece is removed from the conveyor system.

### BRIEF DESCRIPTION OF THE DRAWINGS

The present invention will be described in detail with reference to the following drawings, in which:

FIG. 1 is a top-plan view of a factory line system according to the present invention;

FIG. 2 is a perspective view of a first work station (inspecting station) of the line system of FIG. 1;

FIG. 3 is a perspective view of a second work station (sorting station) of the line system of FIG. 1;

FIG. 4 is a block diagram of the first work station;

FIG. 5 is a block diagram of the second work station;

FIG. 6 is a flowchart of the operation of the first work station;

FIG. 7 is a flowchart of the operation of the second work station; and

FIG. 8 is a timing diagram of the operation of the second work station.

### DETAILED DESCRIPTION

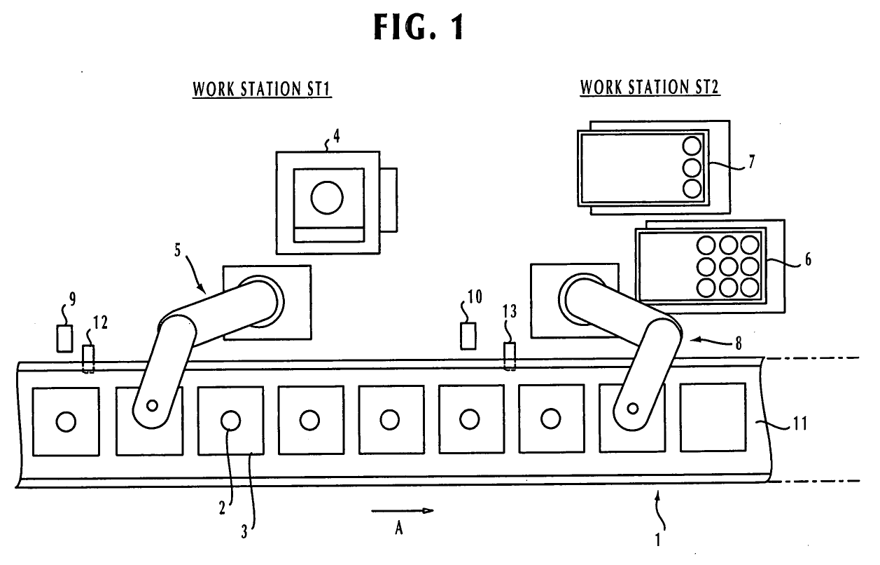

In FIG. 1, there is shown a factory line system according to a first embodiment of the present invention. The factory line system comprises a belt conveyor system 1 and a plurality of work stations located alongside the conveyor system 1. A plurality of pallets 3 are provided at spaced intervals on the conveyor belt 11 which is transported in a direction A. Product items, or workpieces 2 are shown carried on respective pallets 3. For simplicity, only two work stations ST1 and ST2 are shown. Although not shown, one or more work stations located on the upstream side of the work station ST1 are dedicated to perform specified work on each workpiece, such as drilling, for example. Work station ST1 is an inspecting station that includes an inspection unit 4 and a robot arm 5. Inspection unit 4 determines the quality of work performed by the upstream work stations by measuring the flow of compressed air directed into each workpiece picked up from the conveyor belt 11 by the robot arm 5. The inspected workpieces are returned to the conveyor belt 11 by the robot arm 5 and transported to the work station ST2.

Work station ST2 is a sorting station that includes a nondefective-product bin 6, a defective-product bin 7 and a robot arm 8. Robot arm 8 picks up the inspected workpieces from the conveyor system and sorts them into the bin 6 or 7 according to their determined quality.

Inspecting station ST1 is provided with an optical sensor 9 as a proximity sensor that detects when each workpiece has approached a predetermined distance to the pick-up position of robot arm 5 and issues a start timing signal to the robot arm 5 to initiate a pick-up motion. Further provided is a rotary encoder 12 that generates a pulse at a rate corresponding to the moving speed of conveyor belt 11. By counting pulses from the rotary encoder 12, the inspecting station ST1 determines a displacement each workpiece or pallet has traveled upstream from the position of the conveyor belt where it is detected by the optical sensor 9. In the same way, the sorting station ST2 is provided with an optical sensor 10 to detect when each inspected workpiece has approached a predetermined distance to the pick-up position of robot arm 8 and supplies it with a start timing signal. A rotary encoder 13 generates a pulse at a rate corresponding to the moving speed of conveyor belt 11. Sorting station ST2 counts pulses from the rotary encoder 13 to determine a displacement each object has traveled from the position it is detected by the optical sensor 10.

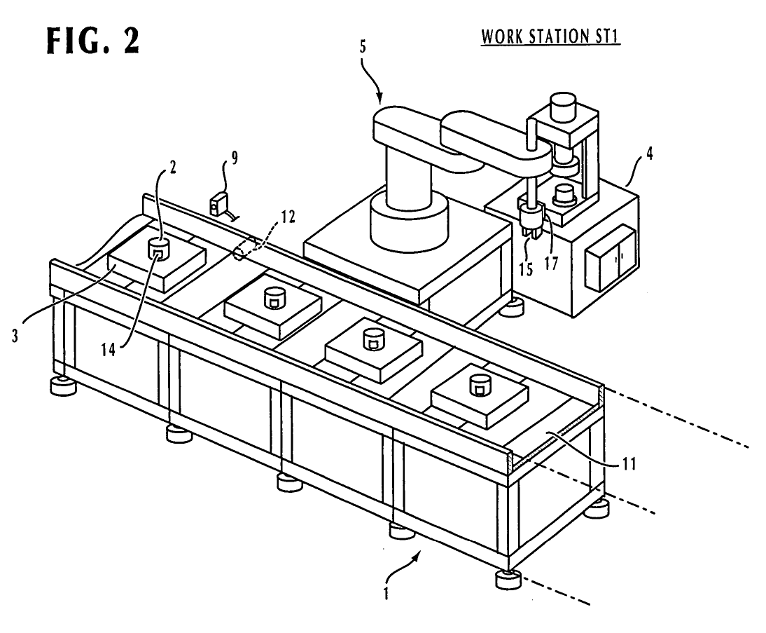

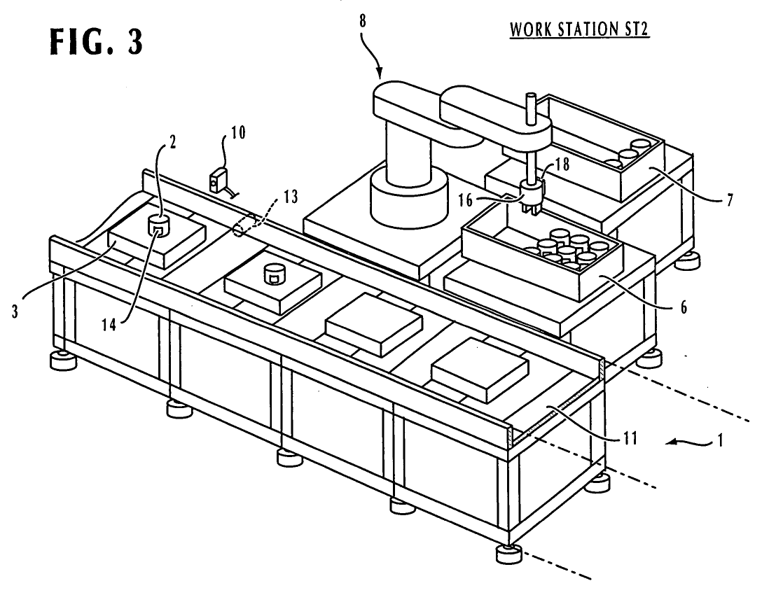

As clearly shown in FIGS. 2 and 3, the workpiece 2 is provided with a wireless data carrier 14, or an IC chip card containing a memory for storing the test data of a workpiece which is obtained at the inspecting station ST1 and then read by the sorting station ST2 for operating its robot arm 8. The IC chip card 14 includes control circuitry and a wireless interface consisting of a digital modem and a coil antenna for receiving test data from the wireless reader/writer 17 and storing it in the memory and then sending the stored test data to the reader/writer 18. Data carrier 14 is further provided with an RDID (Read Identification) tag, not shown.

Robot arm 5 of the inspecting station ST1 has at its lower end a workpiece holding hand, or holder 15 and a wireless reader/writer 17 (FIG. 2). Likewise, the robot arm 8 of the sorting station ST2 has at its lower end a workpiece holder 16 and a wireless reader/writer 18 (FIG. 3). Each wireless reader/writer is used to communicate with the wireless data carrier 14.

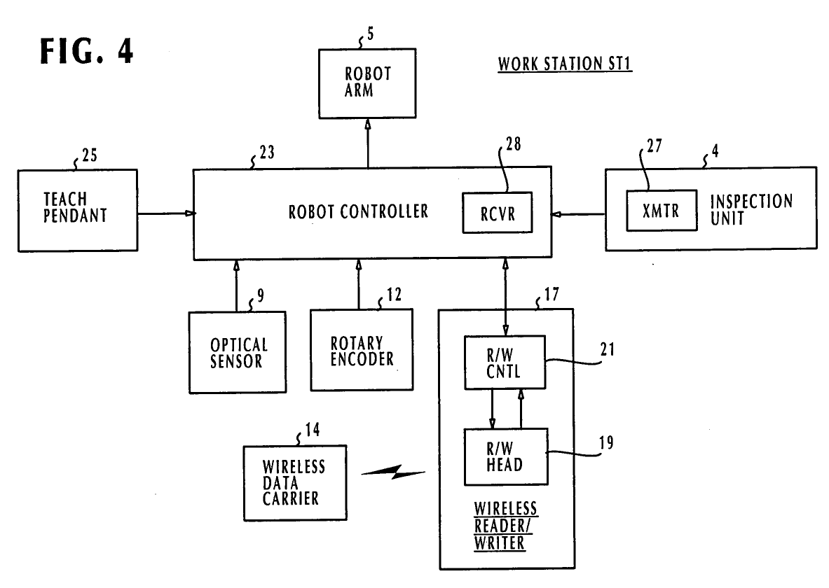

As shown in detail in FIG. 4, the inspecting station ST1 includes a robot-arm controller 23 to which the inspection unit 4, robot arm 5, optical sensor 9, rotary encoder 12, a wireless reader/writer 17 and a teach pendant 25 are connected. Inspection unit 4 includes a sender 27 that encodes a digital signal indicating the result of inspection on a workpiece with a predetermined line code to protect the data from electromagnetic interference and sends it to a line receiver 28 provided in the robot-arm controller 23. Teach pendant 25 is used to teach the robot-arm controller 23 about specified locations of the robot arm 5.

Wireless reader/writer 17 is activated by the robot-arm controller 23 for an interval when a data carrier is brought close to it. Reader/writer 17 includes a read/write head 19 and a read/write controller 21 that receives the test result data of inspection unit 4 from the robot-arm controller 23 when the reader/writer 17 is rendered active and supplies the read/write head 19 with the test result data. Read/write, head 19 includes a coil antenna and a digital modem that digitally modulates the test result data onto a radio-frequency carrier for transmission to the data carrier 14.

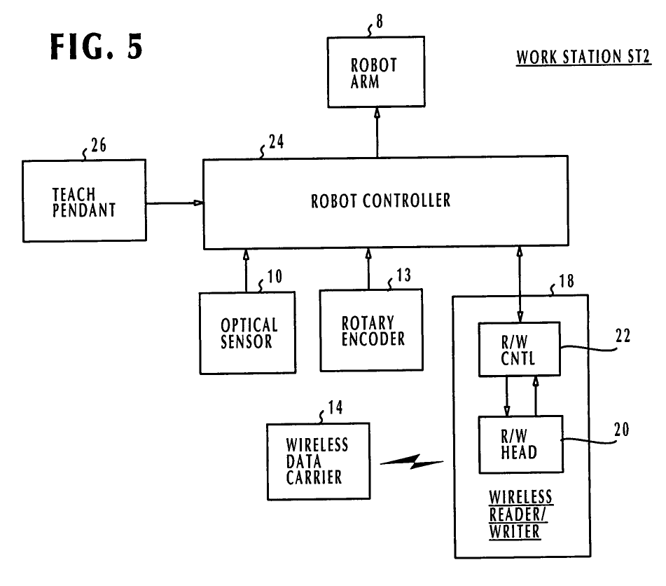

As shown in detail in FIG. 5, the sorting station ST2 includes a robot-arm controller 24 to which the robot arm 8, optical sensor 10, rotary encoder 13, wireless reader/writer 18 and a teach pendant 26 are connected. Teach pendant 26 is used to teach the robot-arm controller 24 about specified locations of the robot arm 8.

Wireless reader/writer 18 is activated by the robot-arm controller 24 for an interval when a data carrier is brought close to it. Reader/writer 18 includes a read/write controller 22 and a read/write head 20. Read/write head 20 includes a coil antenna that receives a wireless signal from the coil antenna of data receiver and a modem that recovers original digital signal from the wireless signal in response to a request signal supplied from the robot-arm controller 24 to the read/write controller 22. When the robot-arm controller 24 receives the test result from the wireless reader/writer 18, the controller 24 operates the robot arm 8 according to the test result.

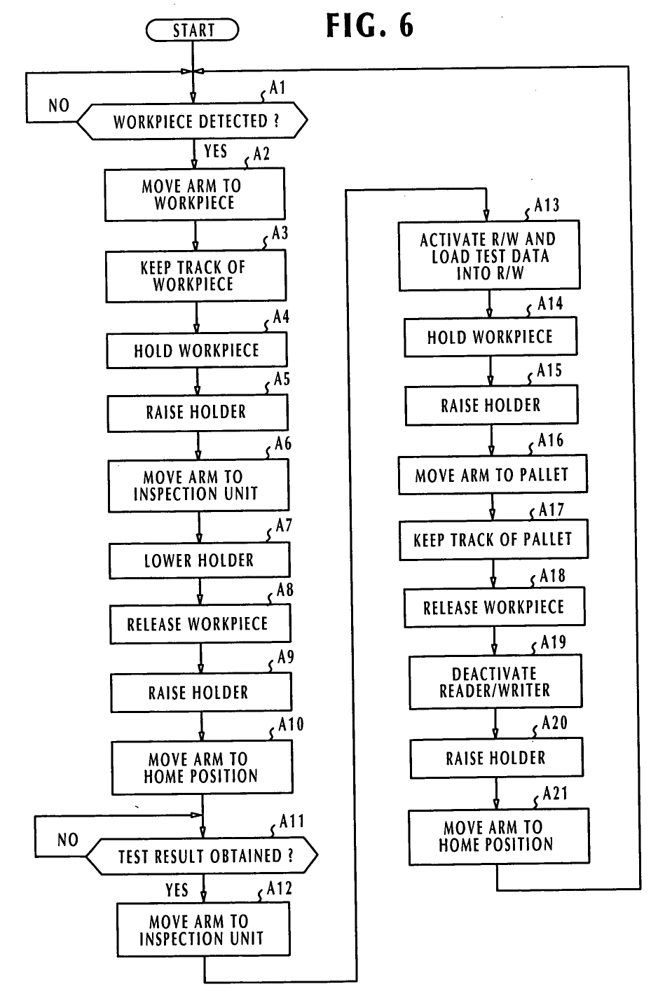

The operation of the robot-arm controller 23 proceeds according to the flowchart of FIG. 6.

Workpieces 2 that have been worked on by preceding work stations are successively transported on the conveyor system 1 carried on respective pallets 3 in the direction of arrow A. When one of these workpieces moves past the inspecting station ST1, the optical sensor 9 supplies a signal to the robot-arm controller 23. Controller 23 recognizes that a workpiece is detected (step A1) and starts counting the pulses supplied from the rotary encoder 12 to determine the location of the workpiece on a real-time basis and moves the robot arm 5 from its home position to the determined location of the workpiece so that its holder 15 comes to a position immediately above the workpiece (step A2). Controller 23 enters a tracking mode in which the holder 15 keeps track of the moving workpiece (step A3). While being moved at the same speed as the workpiece, the holder 15 is lowered to hold the workpiece (step A4). Robot arm's holder 15 is then raised from the pallet 3 (step A5) and the robot arm 5 is moved from the conveyor system 1 to the inspection unit 4 (step A6). Holder 15 is lowered until the workpiece is in contact with the test bed of the inspection unit 4 (step A7) and the holder 15 releases the workpiece (step A8). Then, the robot-arm controller 23 raises the holder 15 (step A9) and moves the arm 5 to its home position (step A10).

When the workpiece is set in position, the inspection unit 4 performs a test on it by supplying pressurized air to determine whether it is a nondefective product or a defective product. The result of the test is converted to a coded signal capable of correcting its bit errors and transmitted from the line transmitter 27 of inspection unit 4 to the line receiver 28 of robot-arm controller 23. Line receiver 28 decodes the received signal and corrects bit errors, if present, caused by electromagnetic interference. When the robot-arm controller 23 receives the coded test result signal (step A11), the robot arm 5 is moved from the home position to the inspection unit 4 (step A12).

When the robot arm's holder 15 approaches the tested workpiece, the controller 23 proceeds to step A13. In this step, the controller 23 sets the wireless reader/writer 17 in a data transfer mode by activating the reader/writer 17 and then loading the coded test result signal into the read/write controller 21. During the time the reader/writer 17 is activated, the read/write controller 21 controls the read/write head 19 to begin transmission of the received test result signal to the data carrier 14 of the tested workpiece for writing the signal into its memory.

As the data transmission proceeds, the controller 23 lowers the holder 15 and operates it to hold the tested workpiece (step A14) and raises the holder 15 from the test bed of the inspection unit 4 (step A15).

Controller 23 determines the current position of the pallet 3, which has been left vacant by the tested workpiece, from the count value of the pulses supplied from the rotary encoder 12 and controls the robot arm 5 so that its holder 15 comes to a position directly above the intended pallet (step A16) and enters a pallet tracking mode in which the holder 15 keeps track of the pallet 3 moving in the direction of allow A (step A17).

During the time the robot arm's holder 15 is keeping track of the pallet, the holder 15 is lowered and releases the workpiece on the surface of the pallet (step A18). Controller 23 terminates the data transfer mode by deactivating the reader/writer 17 (step A19) and raises the arm's holder 15 (step A20) and moves the robot arm 5 to the home position (step A21). Controller 23 now returns to the starting point of the routine to repeat the same process on the next workpiece.

Therefore, during the time between the instant the holder 15 approaches the tested workpiece and the instant the tested workpiece is replaced on the pallet, the wireless reader/writer 17 is activated and test result data is transferred to the data carrier of the tested workpiece and the data carrier 14 cooperates with the read/write controller 21 to receive the transmitted data and perform a writing process on the received data.

When the inspected workpiece moves past the optical sensor 10 of sorting station ST2, the latter sends a signal to the robot-arm controller 24 of sorting station ST2.

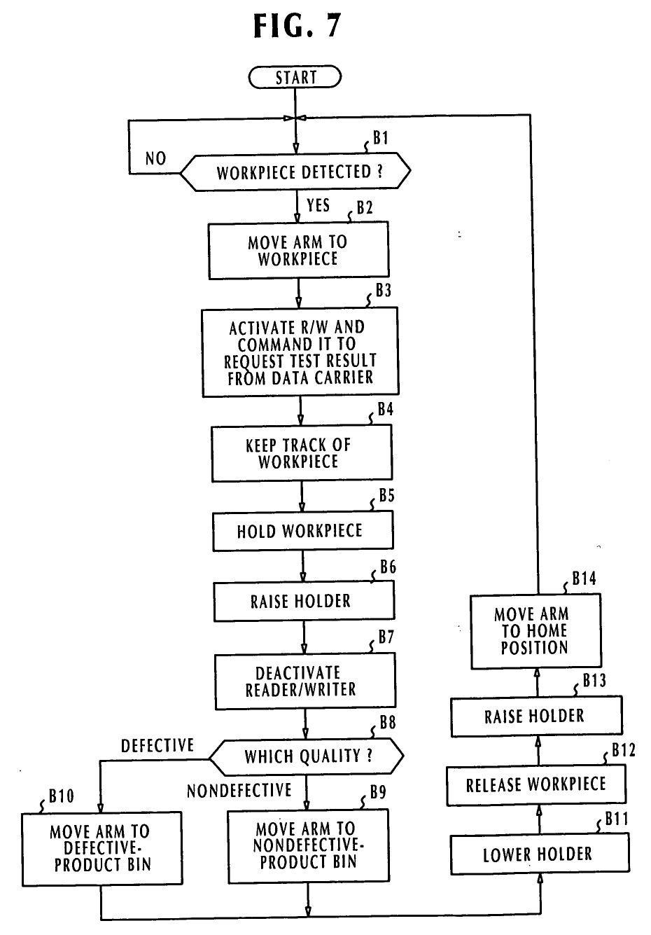

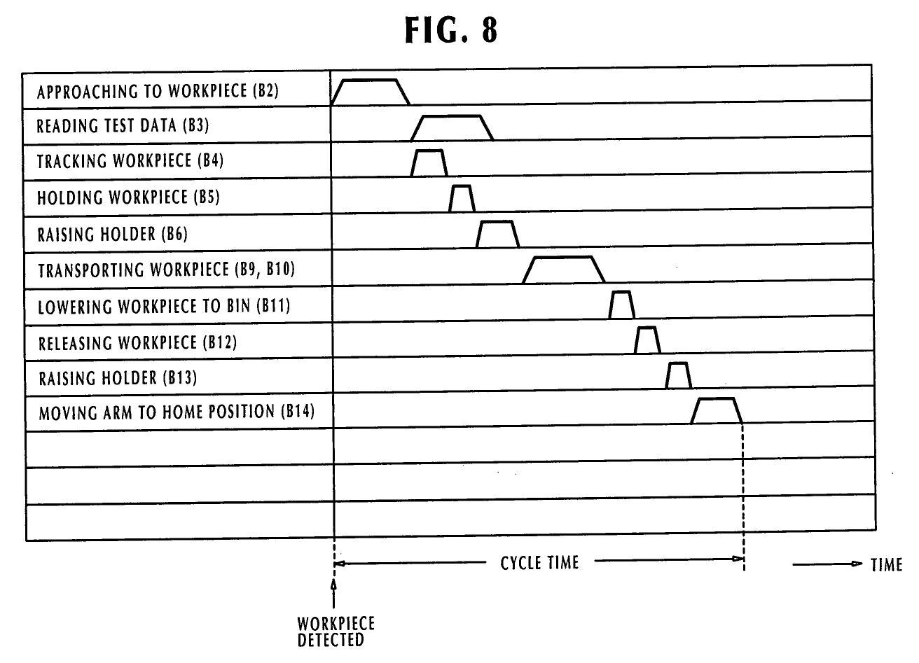

The following is a description of the operation of the controller 24 for sorting tested workpieces with reference to a flowchart and a timing diagram respectively shown in FIGS. 7 and 8.

Controller 24 begins to operate according to the flowchart of FIG. 7 by recognizing that a tested workpiece is arriving (step B1). Controller 24 starts counting the pulses supplied from the rotary encoder 13 to determine the location of the tested workpiece on a real-time basis and moves the robot arm 8 from its home position to the determined location of the workpiece so that its holder 16 comes to a position directly above the workpiece (step B2).

Controller 24 proceeds to step B3 to set the reader/writer 18 in a data fetching mode by activating the wireless reader/writer 18 and then wirelessly commanding its read/write controller 22 to send a request message to the data carrier of the tested workpiece, requesting it to transmit the stored test result data to the reader/writer 18.

Controller 24 enters a tracking mode in which the holder 16 keeps track of the moving workpiece (step B4). While being moved at the same speed as the workpiece, the holder 16 is lowered to hold the workpiece (step B5) and raised from the pallet 3 (step B6).

Since the stored data has been fetched from the data carrier of the tested workpiece in response to the data-fetch request of step B3 before the tested workpiece is raised above the test bed (step B6) as can be seen from FIG. 8, the controller 24 terminates the data fetching mode by deactivating the wireless reader/writer 18 (step B7).

At decision step B8, the controller 24 examines the test result data and determines whether the workpiece is nondefective or defective. If the workpiece is nondefective, the controller 24 proceeds to step B9 to move the robot arm 8 to the nondefective-product bin 6. Otherwise, the controller 24 proceeds to step B10 to move the robot arm 8 to the defective-product bin 7. In either case, the controller 24 lowers the holder 16 (step B11), releases the workpiece in the intended bin (step B12) and raises the holder 16 (step B13). Controller 24 moves the arm 8 to its home position (step A10) and returns to the starting point of the routine to repeat the same sorting process on the next workpiece.

Since data transfer is performed wirelessly while the reader/writer is keeping track of the moving data carrier, a sufficient amount of time is given to transfer or fetch data. Thus, the conveyor system 1 is not required to stop or lower its speed at intervals. Further, the two communicating devices are mutually spaced a short distance apart, the communication channel is protected interference from other sources.

Since the data carrier is attached to the workpiece, it is only necessary to write work-type information of the workpiece into the data carrier if different types of work are performed in sequence on the same conveyor system. If the data carrier is mounted on the pallet as in the aforesaid prior art, it would be necessary to maintain a record indicating the relationship between a workpiece and a pallet carrying it all the way through the conveyor system, in addition to writing the type-of-work information of the workpiece into the associated data carrier.

What is claimed is:

1. A factory line system comprising:
a conveyor system that carries a workpiece;
a data carrier, attached to said workpiece, that stores type-of-work information;
a robot arm provided on one side of said conveyor system for handling the workpiece;
a reader, attached to said robot arm, that wirelessly communicates with said data carrier when the robot arm is proximate to said workpiece; and
control circuitry, associated with said robot arm and said reader, that operates the robot arm to remove said workpiece from said conveyor system, causes said reader to read said type-of-work information from the data carrier while the robot arm is proximate to said workpiece, and operates said robot arm to perform work on said workpiece according to the read type-of-work information.

2. The factory line system of claim 1, wherein said control circuitry operates said robot arm to keep track of the movement of said workpiece on said conveyor system and causes said reader to read said type-of-work information from said data carrier while said robot arm is tracking said workpiece on said conveyor system.

3. A factory line system comprising:
a conveyor system that carries a workpiece;
a data carrier attached to said workpiece;
a robot arm provided on one side of said conveyor system for handling the workpiece;
a writer, attached to said robot arm, that wirelessly communicates with said data carrier when the robot arm is proximate to said workpiece; and
control circuitry, associated with said robot arm and said writer, that operates said robot arm to remove said workpiece from said conveyor system to a work station that performs work on the workpiece, receives a response signal from the work station as a result of the performance of work, causes said writer to write the received response signal into said data carrier while the robot arm is proximate to said workpiece, and operates said robot arm to replace the workpiece to said conveyor system.

4. The factory line system of claim 3, wherein said control circuitry operates said robot arm to keep track of the movement of said conveyor system and causes said writer to write said response signal into said data carrier while said robot arm is tracking the movement of said conveyor system in an attempt to replace the workpiece to the conveyor system.

5. The factory line system of claim 3, further comprising:
a further robot arm provided on one side of said conveyor system for handling the workpiece;
a reader, attached to said robot arm, that wirelessly communicates with said data carrier; and
control circuitry, associated with said further robot arm and said reader, that operates the further robot arm to remove said workpiece from said conveyor system, causes said reader to read said response signal from the data carrier while the robot arm is proximate to said workpiece, and operates said further robot arm to perform work on said workpiece according to the read response signal.

6. The factory line system of claim 5, wherein said control circuitry operates said further robot arm to keep track of the movement of said workpiece on said conveyor system and causes said reader to read said type-of-work information from said data carrier while said further robot arm is tracking said workpiece.

7. The factory line system of claim 5, wherein said response signal is a coded signal capable of correcting an error introduced therein by interference.

8. A factory line system comprising:
a conveyor system that carries a workpiece;
a data carrier on said workpiece;
a robot arm, provided on one side of said conveyor system, for handling the workpiece;
a communication device, attached to said robot arm, that wirelessly communicates with said data carrier when the robot arm is proximate to said workpiece; and
control circuitry, associated with said robot arm and said communication device, that operates said robot arm to hold said workpiece and causes said communication device to communicate with said data carrier while the robot arm is proximate to the workpiece.

9. The factory line system of claim 8, wherein said control circuitry operates said robot arm to keep track of the movement of said workpiece on said conveyor system and causes said communication device to communicate with said data carrier while said robot arm is tracking said workpiece.

10. The factory line system of claim 8, wherein said data carrier includes an integrated circuit chip.

11. The factory line system of claim 8, wherein said communication device wirelessly communicates with said data carrier using a coded signal capable of correcting an error therein.

12. A method of operating a factory line system including a conveyor system and a robot arm provided on one side, of said conveyor system, comprising the steps of:
a) providing a workpiece on said conveyor system;
b) attaching a data carrier to said workpiece;
c) attaching a communication device to said robot arm, said communication device being capable of wirelessly communicating with said data carrier when the robot arm is proximate to said workpiece; and
d) operating said robot arm to hold said workpiece and causing said communication device to communicate with said data carrier while the robot arm is proximate to said workpiece.

13. The method of claim 12, wherein step (d) comprises the steps of operating said robot arm to keep track of the movement of said workpiece on said conveyor system and causing said communication device to communicate with said data carrier while said robot arm is tracking said workpiece on said conveyor system.

14. The method of claim 12, wherein step (d) comprises the steps of:
d1) operating said robot arm to remove said workpiece from said conveyor system to a work station;
d2) performing work on the workpiece on said work station;
receiving a response signal from the work station as a result of the performance of work; and
d3) causing said communication device to write the received response signal to said data carrier and operating said robot arm to replace the workpiece to said conveyor system.

15. The method of claim 12, wherein said data carrier stores type-of-work information, wherein step (d) comprises the step of causing said communication device to read said type-of-work information from the data carrier while the robot arm is proximate position and operating said robot arm to perform work on said workpiece according to the read type-of-work information.

16. The method of claim 14, wherein step (d3) comprises the steps of:
operating said robot arm to keep track of the movement of said conveyor system; and
causing said communication device to write said received response signal into said data carrier while said robot arm is tracking the movement of said conveyor system in an attempt to replace the workpiece to the conveyor system.

17. A factory line system including a robot arm provided in the neighborhood of a conveyor system on which workpieces of different types of work to be performed are transported, said robot arm having a holder fitted to a forward end of the robot arm for holding one of said workpieces and removing said one workpiece from the conveyor system, comprising:
a data carrier, attached to each of said workpieces, that stores information indicating the type of work of the workpiece;
tracking control means that controls said robot arm so that said forward end of the robot arm keeps track of the movement of said one workpiece on said conveyor system;
reading means, attached to said forward end of said robot arm, that wirelessly communicates with said data carrier to read the type-of-work information of said one workpiece stored in said data carrier; and
work control means that determines work to be performed according to the information read by said reading means and controls said robot arm according the determined work,
wherein said reading means performs reading of said stored information from said one workpiece during a time interval that runs from the instant said forward end of the robot arm approaches said one workpiece while the same is being transported on said conveyor system and then kept track of by said forward end to the instant said one workpiece is removed from said conveyor system.

18. A factory line system including a robot arm provided in the neighborhood of a conveyor system on which a workpiece is transported, said robot arm having a holder fitted to a forward end of the robot arm for holding said workpiece and removing said one workpiece from the conveyor system to a work station and replacing the workpiece to said conveyor system after work is performed by said work station on said workpiece, comprising:
a data carrier, attached to said workpiece, into which information is written and from which the stored information is read out;
tracking control means that controls said robot arm so that said forward end of the robot arm keeps track of the movement of said conveyor system;
communication means that receives work result information from said work station, said information indicating a result of said work performed by said work station on said workpiece; and
writing means, attached to said forward end of said robot arm, that writes the work result information of said workpiece into said data carrier,
wherein said writing means performs writing of said work result information into said data carrier during a time interval that runs from the instant said forward end of the robot arm approaches said workpiece on said work station and then keeps track of the movement of said conveyor system to the instant said workpiece is replaced to the conveyor system.

19. A factory line system comprising:
a conveyor system on which a workpiece is transported;
a first robot arm having a holder fitted to a forward end of the first robot arm for holding said workpiece and removing said one workpiece from the conveyor system to a work station and replacing the workpiece to said conveyor system after work is performed by said work station on said workpiece;
a second robot arm having a holder fitted to a forward end of the second robot arm for holding said workpiece and removing said one workpiece from the conveyor system to perform work;
a data carrier, attached to said workpiece, into which information is written and from which the stored information is read out;
first tracking control means that controls said first robot arm so that said forward end of the first robot arm keeps track of the movement of said conveyor system;
communication means that receives work result information from said work station, said information indicating a result of said work performed by said work station on said workpiece; and
writing means, attached to the forward end of said first robot arm, that writes the work result information of said workpiece into said data carrier,
second tracking control means that controls said second robot arm so that the forward end of the second robot arm keeps track of the movement of said workpiece on said conveyor system;
reading means, attached to said forward end of said robot arm, that wirelessly communicates with said data carrier to read the type-of-work information of said one workpiece stored in said data carrier; and
work control means that determines work to be performed according to the information read by said reading means and controls said second robot arm according the determined work,
wherein said writing means performs writing of said work result information into said data carrier during a time interval that runs from the instant said forward end of the first robot arm approaches said workpiece on said work station and then keeps track of the movement of said conveyor system to the instant said workpiece is replaced to the conveyor system,
wherein the holder of said second robot arm holds said workpiece while the forward end of the second robot arm is tracking the movement of the workpiece on said conveyor system, and
wherein said reading means performs reading of said stored information from said one workpiece during a time interval that runs from the instant said forward end of the second robot arm approaches said one workpiece while the same is being transported on said conveyor system and then kept track of by said forward end of said second robot arm to the instant said one workpiece is removed from said conveyor system.
